(19) United States
(12) Patent Application Publication
(10) Pub. No.: US 2017/0102955 A1
(43) Pub. Date: Apr. 13, 2017

(54) SOFTWARE PLATFORM FOR EMBEDDED SYSTEMS

(71) Applicant: Renesas Electronics America Inc., Santa Clara, CA (US)

(72) Inventors: Brandon Cranford Hussey, Durham, NC (US); Bhupesh Kharwa, San Ramon, CA (US); Jon Matthew Brabender, Cary, NC (US); Kristine M. Jassmann, Santa Cruz, CA (US); John L. Dallaway, Cambridge (GB); James Mark Deadman, Kent (GB)

(21) Appl. No.: 15/290,350

(22) Filed: Oct. 11, 2016

Related U.S. Application Data
(60) Provisional application No. 62/239,945, filed on Oct. 11, 2015.

(51) Int. Cl. G06F 9/445

(52) U.S. Cl. CPC G06F 9/44505; G06F 8/60

(57) ABSTRACT

A software platform for embedded systems. In one embodiment, a package is received and stored in memory of a computer system. The package comprises a plurality of software components and a real time operating system (RTOS). The plurality of software components are configured to provide respective services to any one of a plurality of applications executing on a microcontroller. The RTOS is configured for direct exchange of information with each of the plurality of software components.

### RELATED APPLICATIONS

This application claims the domestic benefit under Title 35 of the United States Code §119(e) of U.S. Provisional Patent Application Ser. No. 62/239,945 , entitled “Microcontroller Development Platform,” filed Oct. 11, 2015, which is hereby incorporated by reference in its entirety and for all purposes as if completely and fully set forth herein.

### BACKGROUND

Embedded systems are computer systems that do not look like computer systems to most people. They are hidden within and form a part of larger mechanical or electrical systems. Today more processors are used in embedded systems than in personal computers. And embedded systems are becoming smarter and more connected using wired or wireless connections as we enter the Internet of Things (IoT) age.

Embedded systems include hardware and software. The hardware typically includes a microcontroller unit (MCU), which is essentially a computer on a single integrated circuit. MCU architectures vary widely. However, nearly all contain memory (e.g., Flash memory) for storing embedded software, and one or more central processing units (CPUs) for executing instructions of the embedded software. The size of the Flash memory is limited to reduce MCU cost. The small size substantially constrains the size of embedded software an MCU can hold.

MCUs contain additional hardware such as random access memory (RAM), configuration registers, and programmable peripherals such as general purpose timers, general purpose input/output (GPIO) ports, serial communication controllers, Ethernet controllers, DMA controllers, LCD controllers, etc.

MCUs are often embedded in other machinery or products, and include embedded software specifically designed to control or otherwise interface with the specific product in which the microcontroller is embedded. As will be discussed in more detail below, embedded software can be stored in Flash memory on the MCU, after the MCU has been manufactured and sold. Thus, as can be seen from the disclosure provided herein, MCUs stand in contrast to the microprocessors used in general purpose computers or other general purpose applications.

By reducing the size and cost through the use of MCUs, particularly as compared to a design that uses a separate microprocessor, memory, and input/output devices, MCUs make it economical to digitally control many devices and processes. However, despite their many advantages particularly in the embedded space, MCUs typically have much less available memory than microprocessors because components such as the memory and CPU are built directly onto the chip. Moreover, the memory embedded in an MCU cannot easily be “swapped out” or “added to,” as is the case with the external memory devices that are typically connected to microprocessors. As such, making optimal use of a MCU's very limited memory is of the utmost importance when building embedded software for use in MCUs. Such constraints are much less significant when dealing with programs that are designed for use with microprocessors.

### SUMMARY

A software platform for embedded systems. In one embodiment, a package is received and stored in memory of a computer system. The package comprises a plurality of software components and a real time operating system (RTOS). The plurality of software components are configured to provide respective services to any one of a plurality of applications executing on a microcontroller. The RTOS is configured for direct exchange of information with each of the plurality of software components.

### BRIEF DESCRIPTION OF THE DRAWINGS

The present invention may be better understood in its numerous objects, features, and advantages made apparent to those skilled in the art by referencing the accompanying drawings.

FIG. 1 is a block diagram illustrating an example embedded system.

FIG. 2 is block diagram illustrating an example of a system for building embedded software.

FIG. 3 is a block diagram illustrating how software modules of a software stack can be swapped without affecting a common application programming interface of FIG. 1.

FIGS. 4A and 4B illustrate advantages of a software platform configured for a single operating system.

FIG. 4C and 4D illustrate advantages provided by common device drivers of FIG. 1.

FIGS. 5A-5C are block diagrams of microcontrollers and software components embedded therein.

The use of the same reference symbols in different drawings indicates similar or identical items.

### DETAILED DESCRIPTION

FIG. 1 is a block diagram of an embedded system 100 that controls a product such as a medical device, office machine, appliance, etc. Embedded system 100 includes embedded software 102 stored in Flash memory (not shown) in MCU 104. MCU 104 is any one of a family of MCUs provided by one vendor such as Renesas Electronics Corporation. Each MCU in the family has different hardware features. FIG. 1 shows example MCUs 104A-104C in the family along with distinguishing features.

Embedded software 102 typically includes one or more applications 106 and a software platform (also known as system software) 107 that supports the one or more embedded software developed applications 106. A software platform is an abstraction layer that hides the details an MCU. With little or no modification, software platform 107 can support application 106 on more than one of MCUs 104A-104C.

Software platform 107 includes several components that provide services or functionality to application 106 and to each other. Specifically, software platform 107 includes a system framework 108, common application programming interfaces (CAPIs) 110, qualified additional software components 112, and verified additional software components 114. All of these components can be delivered by one vendor, after the vendor extensively tests the components to insure they meet industry standards and interoperability with each other and MCU 104. Qualified additional software components 112 and verified additional software components 114 are optional components that embedded software developers can add to the software platforms they build.

Although extremely difficult and time consuming, embedded software developers could write “bare metal” software, which means an application that interacts directly with MCU hardware and without any intermediate software components like device drivers. Because embedded software development has reached a cost point and capability stand point, embedded software developers don't do this. Today developers can integrate preexisting components to create a software platform using integrated development environments (IDEs). Software platforms decouple the application development process from the underlying hardware implementations.

Vendors that supply MCUs typically provide software components for building a software platform. The vendor may also provide sample applications, which can be modified to fit the design goals of embedded software developers. In this disclosure, for ease of embedded system development the vendor (e.g. Renesas Electronics Corporation) that supplies MCU 104 can offer all components of a software platform that are needed by embedded software developers via a website. Many of the software components are developed by third party software vendors. For example, software platform 107 can include a real time operating system (RTOS) called ThreadX or a file allocation table (FAT) file system called FileX, both from Express Logic, Inc.

Prior to the creation of the systems and methods disclosed herein, embedded software developers faced a difficult task when attempting to build or modify embedded software for use in a specific dedicated product (e.g., a medical device). For instance, before any software platform could be built or modified, an embedded software developer faced a challenging task just in attempting to figure out how all of the components relate to each other. This was a particularly difficult task when components were developed by many different companies. Any modification was costly, time consuming, and inherently risky, since the modification could easily break the embedded software and prevent the proper functioning of the MCU and/or the product into which the MCU is embedded. Moreover, different MCUs are configured differently with respect to various aspects of their functionality, such as, e.g., memory, processor speed, and so forth. These variables further add to the complexity faced by embedded software developers in building or modifying embedded software to work for a given MCU

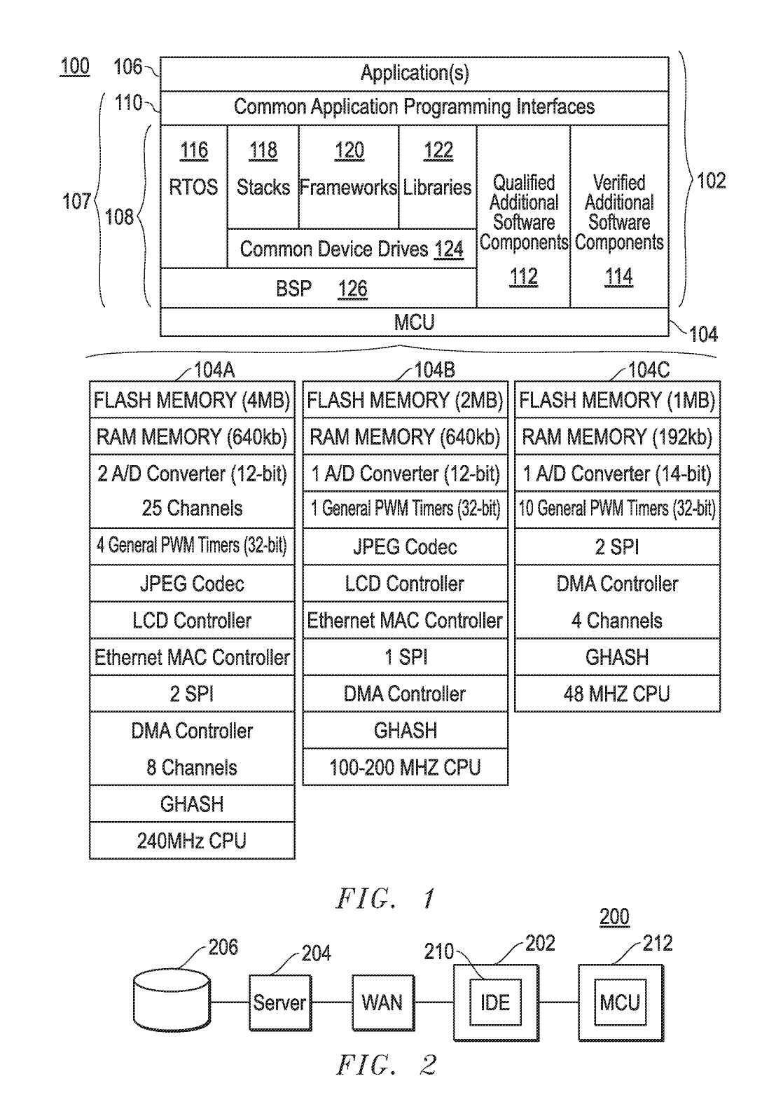

FIG. 2 illustrates a system 200 for building or modifying embedded software such as embedded software 102 of FIG. 1 using software components extensively tested and provided by the manufacturer of MCU 104. System 200 includes a general purpose computer 202 coupled to server 204 via a wide area network (WAN) such as the Internet. Server 204 is coupled to memory 206 that stores files containing software components, including software components 108-114, that can be used to build a software platform like software platform 107. A vendor can send software packages to computers like computer 202 via server 204 in response to receiving requests from developers. Each package includes one or more software components from memory 206. For example server 204 can send a package P containing software components 108-114. Package P can include additional software components or sample applications.

Computer 202 includes IDE 210 for building embedded software like embedded software 102. IDE 210 is an application program that executes on computer 202 and provides comprehensive facilities for software development. IDE 210 presents a single program in which most or all software development is done through use of tools that are chained together to make embedded software development easier. IDE 210 can be downloaded from server 204 and includes source code text editor, build automation tools including a complier and linker, and a debugger.

A source code editor of IDE 210 is a program executing on computer 202 for writing or modifying source code of, for example, application 106 via a graphical user interface (GUI). Source code is a collection of instructions, (possibly with comments), that is written using a human-readable programming language such as C. The present invention will be described with reference to a source code editor for writing or editing source code in C, it being understood the present invention should not be limited thereto. A higher level programming language like C is for the most part independent of an MCU's specific architecture.

Source code must be translated into binary object code before it can be executed on a CPU. A compiler of IDE 210 is a program executing on computer 202 that can translate or “compile” source code into binary object code (hereinafter object code). In contrast to source code, object code is not human-readable. Object code represents processor instructions using the binary number system's two binary digits, 0 and 1. Object code assigns a bit string to each instruction. A compiler can be configured to optimize the resulting object code for use with a particular MCU. Compilers can take into account various constraints and considerations such as limited memory that is typically available on an MCU. For example, a compiler can be configured to produce code that will run faster on a given MCU or occupy less Flash memory. The compiler of IDE 210 can compile the application 106 into an object code component. If they are provided in source code format, compiler IDE 210 can also compile software components 108-114 into object code components. A linker can used to combine the object code components into a unified executable image (i.e., .exe file). This image can be loaded into Flash memory of a test MCU of a development board 212.

Even the most experienced developers usually do not get it right on their first try. Certain errors, often called bugs, can occur in embedded software, causing it to function in an unexpected manner. For example, software being tested may crash when it tries to implement an instruction not available on the CPU, or the software may crash when it attempts to access unavailable or protected memory. Sometimes these errors are easy to fix, while other bugs are very difficult to trace. This is especially true for large software projects that consist of several thousand lines of code. Debuggers are used to test and debug code for problems. Common debuggers provide features that include the capability to examine an MCU's RAM; pausing or stopping the execution of code at defined instruction locations by setting breakpoints; single-stepping (execute one instruction at a time) through the code; and looking at a history of executed code (trace). When software crashes, the debugger can highlight the offending source code in a view if the debugger is a source-level debugger, which is commonly seen in IDEs.

With continuing reference to FIGS. 1 and 2 a software platform like software platform 107 is a comprehensive, integrated platform that can provide the essential software components that are needed for application support. Framework 108 includes several software components such as a real time operating system (RTOS) 116, stacks 118, frameworks 120, libraries 122, common device drivers (CDDs) 124, and a board support package (BSP) 126. The BSP performs tasks such as setting up clocks, interrupts etc. In one embodiment, BSP 126 is unique to the underlying MCU. The software components of platform 107 interoperate with other and MCU 104 to support application 106. The components of software platform 107 are extensively tested to guarantee developers that software platform 107 and its components meet industry standards and will interoperate according to their specifications. The guarantee gives developers confidence software platforms like software platform 107 will properly support their applications.

All services and functions provided by MCU 104 and software platform 107, including qualified software components 112 and/or verified software components 114 added by a developer, can be accessed through CAPIs 110. Each CAPI 110 defines a high level interface of services implemented by an underlying software or hardware component, including its inputs and outputs. Application 106 can directly access registers of MCU 104 and bypass all of the CAPIs 110.

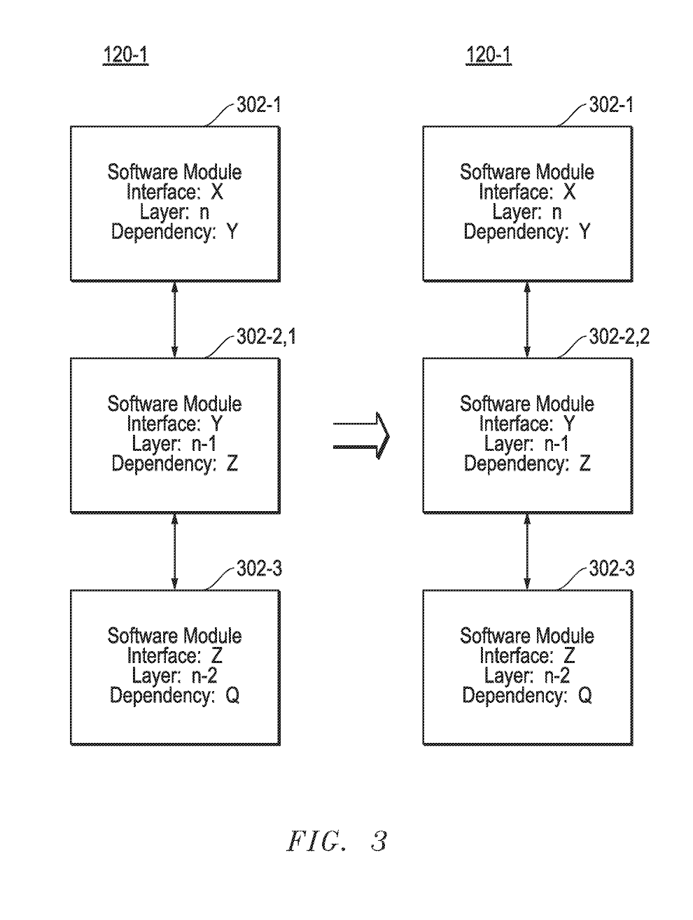

CAPIs 110 are “common” or implementation independent. Changes to an implementation does not require a change in the corresponding CAPI. To illustrate, FIG. 3A illustrates a graphical representation of an implementation a software component (e.g., framework 120-1) that includes software modules 302 aligned in a stack, which are logically and schematically connected to application 106 via one of the CAPIs 110. The connections can represent any method of transferring information between connected software modules 302, and/or between the CAPI (not shown) directly connected to it.

Each software module 302 will provide some functionality to the software component. In addition to supplying functionality (as output), a software module may also have an input requirement, or dependency, that must be met in order to work. As can be seen from the additional detail provided by FIG. 3A, each software module 302 includes an interface and, at least potentially, has a dependency based on information needed from another software module. The relationships between these interfaces and dependencies enable the software modules to be “stacked” by matching the information that one software module provides with the information that another software module requires in order to function properly.

An interface defines a set of functionality that must be supported by a module 302 that adheres to that interface. In a sense, an interface provides an agreed upon “contract” between two software modules. Interfaces can be built from various data structures, such as, e.g., “typedefs,” enumerations, and macros, as some examples.

Interfaces allow embedded software developers to modify components by swapping modules in and out of a stack without having to access and/or modify the underlying code itself or the corresponding CAPI. This structure and functionality enables users to swap modules in and out to suit their needs, but without any risk of introducing bugs into (or otherwise compromising the integrity of) the software component.

Software modules that have an interface requirement must adhere to that interface. At least potentially, each module can also include a dependency, although some software modules may not be dependent on information received from any other module. If a software module has a dependency requirement, that dependency requirement will be for information received from another interface pursuant to the definition of that interface. For example, software module 302-1 is dependent on information received from interface Y, which is the interface of software module 302-2,1. Software module 302-2,1 is, in turn, dependent on information received from interface Z, which is the interface of software module 302-3. Software module 302-3 contains interface Z and thus can provide information to software module 302-2,1 according to the constraints and parameters of interface Z.

Importantly, software modules that do not “match” cannot be stacked directly on top of each other. For instance, using FIG. 3 as an example, software module 302-1 cannot be stacked directly on top of software module 302-3 without having software module 302-2,1 (or another software module that has the same interface and dependency as those of software module 302-2,1)) in between them. Stacking software module 302-1 directly on top of software module 302-3 would not work because software module 302-3 provides information according to interface Z, which would not be properly understood by software module 302-1, which has a dependency that requires information provided by interface Y. Moreover, stacking software module 302-1 directly on top of software module 302-3 would cause a further problem in that software module 302-1 is dependent on information provided by interface Y, which software module 302-3 does not and cannot provide in this example embodiment. Thus, if software module 302-1 was stacked directly on top of software module 302-3, software module 302-1 would receive information that it is not programmed to handle (from interface Z), but would not receive the information that is required for software module 302-1 to function properly (from interface Y).

As will be discussed in more detail below, the use of predefined interfaces enables software modules to be swapped in and out by embedded software developers. To illustrate, suppose framework 120-1 of FIG. 3A takes form in a Wifi communication framework that is configured to work with a first set of WiFi communication chips that are external to MCU 104. Software module 302-2,1 is unique to the first set of WiFi chips. However, the developer prefers to use a second, different Wifi chip set for his embedded project. This second Wifi chip set requires a different Wifi communication stack in platform 107; the stack shown in FIG. 3A in general, and module 320-2,1 in particular, will not accommodate the second WiFi chip set. IDE 210 allows the developer to swap software module 302-2,1 with another software module 302-2,2 provided from server 204 and written for use with the second WiFi chip set. Importantly, a developer can simply swap module 302-2,1 with 302-2,2 in the stack without having to make changes in the corresponding CAPI 110. FIG. 3B illustrates the WiFi communication stack after software module 302-2,1 is swapped with module 322-2,2. The new WiFi communication stack can be compiled and linked into software platform 107 without having to modify the corresponding CAPI 110. Also, the new WiFi stack accommodates the developer's preference to use the second WiFi chip set without having to make changes to application 106.

CDDs 124 create abstract functions that are used to make hardware (e.g., timers) of MCU 104 do something. CDDs 124 allow developers who aren't experts in MCU hardware to write useful applications without having to know the nitty-gritty details. This can be extremely useful for developers who work with multiple MCU hardware architectures and who need to port applications from one to another.

CDDs 124 operate based on CDD configuration information read from Flash memory of MCU 104 at runtime. In one embodiment, the MCU manufacturer writes the CDD configuration information to a designated area of Flash memory before an MCU is shipped. The designated area Flash memory that holds CDD configuration information is separate and apart from the Flash memory that receives and stores embedded software 102.

MCU 104 is one of a family of MCUs that vary in hardware features. CDD configuration information written to the designated area of Flash memory of an MCU depends on the hardware of the MCU. CDD configuration information for MCU 104A of FIG. 1 is different from CDD configuration information for MCU 104C. CDD configuration information may include, for example: the size of RAM; the size of the Flash memory; the version number, the base address for control registers, and quantity of peripherals for each unique set of peripherals (e.g., timers); the identity of package pins of a package containing the, which are or are not connected to die pads, etc.

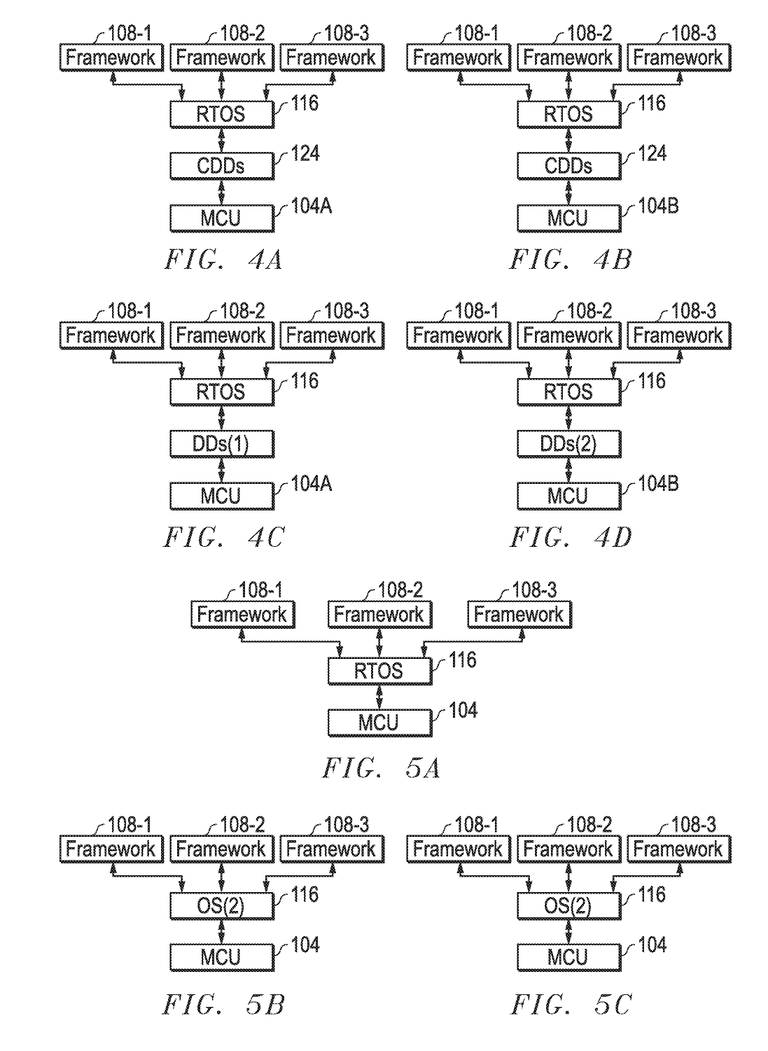

Each of the CDDs 124 access the designated area of Flash memory during runtime to read the CDD configuration for the CDD 124. CDD configuration information enables the “common” CDDs 124 to configure themselves into “specific” device drivers at runtime. In other words, the operation of CDDs 124 is directly dependent on CDD configuration information it reads from Flash memory during runtime. For example, a CDD 124 will operate one way when it reads a first version number for peripheral timers, and the CDD 124 will operate in another way when it reads a second version number for peripheral timers. This self-configuration enables CDDs 124 to adapt to the unique hardware resources of MCU 104. The ability to configure itself based on CDD configuration information stored in Flash memory by the MCU manufacturer makes CDDs 124 “commonly” usable on any one of the family of MCUs 104A-104C and provides advantages. FIGS. 4A-4D illustrate the advantages of CDDs 124 over static device drivers (DDs), or drivers that lack the ability to be used with MCUs having different hardware features. FIGS. 4A and 4B show that the same CDDs 124 can be used to interface components of framework 108 to different MCUs 104. In contrast, FIGS. 4C and 4D show that distinct sets of static device drivers (i.e., DDs(1) and DDs(2)) are needed to interface the same components of framework 108 to different MCUs (i.e., MCU 104A and 104C). Offering CCDs 124 to developers simplifies the process of building software platforms such as software platform 107 in addition to giving developers options to select one MCU from a family, and then subsequently change the MCU selection to another in the family without having to swap device drivers to accommodate the change. Moreover, substantially less testing is needed to insure interoperability when one set of drivers (i.e. CCDs 124) are offered to developers when compared to the testing needed to insure interoperability of multiple sets of device drivers (i.e., DDs(1) and DDs(2)).

Stacks 118, frameworks 120, libraries 122, qualified additional software components 112, and verified additional software components 114 (collectively referred to as middleware components) provide services to application 106 and each other. Middleware components are often viewed as software that has been abstracted out of the application for a variety of reasons such as to allow reusability with other applications, to decrease development costs or time by purchasing it off-the-shelf (OTS) through a third party software vendor, or to simplify application code. Middleware makes it easier for software developers to implement communication, input/output, etc., so they can focus on the specific purpose of their application such as application 106. Example middleware components include TCP/IP stacks, application layer protocols (e.g., file transfer protocol (FTP), Hypertext Transfer Protocol (HTTP), etc.), WiFi stacks, etc.

Application complexity can increase when complex functional features such as wireless communication are needed, to the point where it becomes inefficient not to have an operating system to handle various tasks on behalf of the application. RTOS 116 is an operating system that can serve real-time application data as it comes in, typically without buffering delays. RTOS 116 has an advanced algorithm for scheduling tasks. RTOS 116 also has communication, synchronization, timer, memory management, and interrupt management facilities. An important difference between most embedded operating systems (e.g., RTOS 116) and desktop operating systems is that the embedded operating system and middleware components can be statically linked together with the application into a single executable, which can be stored in Flash memory of an MCU.

Software platform 107 is built from preexisting software components provided by a single vendor as noted above. The vendor, however, only provides RTOS 116 to developers via server 204, notwithstanding the fact that other, functionally different RTOS s are available and could also be provided to developers. RTOS 116 is extensively tested against the other middleware components offered by the vendor to insure interoperability. Importantly, software platform 107 is built with RTOS 116 directly coupled to middleware components and/or CAPIs 110; there is no operating system abstraction layer coupled to RTOS 116. In other words information is exchanged directly between RTOS 116 and, for example, middleware components 118-122. An operating system abstraction layer could be offered to developers, which in turn could provide the advantage of allowing developers to choose the RTOS they feel best optimizes their software project. Including an operating system abstraction layer in software platforms, however, will make the software platform slower and less compact. Perhaps more importantly, substantially more testing would be needed to guarantee interoperability of components such as middleware components of framework 108 with each of the RTOS s offered by the vendor. FIGS. 5A-5C illustrates this disadvantage more clearly. FIG. 5A shows three middleware components of framework 108 and RTOS 116. The connections between each framework 108 and RTOS 116 represents the exchange of information during tests to determine interoperability. FIG. 5B shows the same three middleware components of framework 108 and operating system OS(1), while FIG. 5C shows the middleware components and operating system OS(2). Like FIG. 5A, the connections between middleware components of framework 108 and OS(1), and the connections between middleware components of framework 108 and OS(2), represent the exchange of information during interoperability testing. A comparison of FIG. 5A with FIGS. 5B and 5C shows that by offering only one operating system (i.e., RTOS 116) to developers, the vendor substantially reduces the amount of testing needed to insure middleware component interoperability when compared to the amount of testing that would be needed if the vendor offered several operating system options (i.e., OS(1) and OS(2)).

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A computer readable medium (CRM) comprising a software platform for supporting any one of a plurality of application programs executing on a microcontroller unit (MCU), the software platform comprising:
a plurality of software components that provide services to any one of the plurality of application programs;
an operating system (OS);
wherein the OS is configured to directly exchange information with each of the plurality of software components.

2. The CRM of claim 1 wherein the plurality of software components comprise a first common device driver (CDD), wherein the first CDD is configured to read first configuration information stored in flash memory of the MCU, wherein the first CDD is configured to operate according to the first configuration information.

3. The CRM of claim 2 wherein the plurality of software components comprise a second CDD, wherein the second CDD is configured to read second configuration information stored in the flash memory of the MCU, wherein the second CDD is configured to operate according to the second configuration information.

4. The CRM of claim 1 wherein the plurality of software components comprise a first common application program interface (CAPI) that provides one or more first services to an application executing on the MCU, wherein the first CAPI is implementation independent.

5. The CRM of claim 4 wherein the plurality of software components comprise a first software component corresponding to the first CAPI, wherein the first software component comprises a stack off software modules, wherein at least one of the software modules can be replaced in the stack with another software module.

6. The CRM of claim 1 wherein the plurality of software modules comprises a board support package.

7. The CRM of claim 1 wherein the plurality of software components and the RTOS are downloaded to the CRM from a server.

8. The CRM of claim 7 wherein the plurality of software components and the RTOS are tested to insure interoperability with each other.

9. The CRM of claim 8 wherein the plurality of software components are not tested for interoperability with another operating system.

10. The CRM of claim 1 wherein the plurality of software components and the RTOS are configured for implementation on any one of a plurality of MCUs having different hardware characteristics, wherein the plurality of software components comprise a plurality of common device drivers, wherein the plurality of software components comprise a plurality of middleware components, wherein the plurality of common device drivers abstracts any one of the plurality of MUCs for the plurality of middleware components.

11. The CRM of claim 10 wherein the plurality of middleware components comprise a plurality of stacks, a plurality of frameworks, and a plurality of libraries.

12. A method comprising:
receiving and storing a package in memory of a computer system, wherein the package comprises a plurality of software components and a real time operating system (RTOS);
wherein the plurality of software components are configured to provide respective services to any one of a plurality of applications executing on a microcontroller;
wherein the RTOS is configured for direct exchange of information with each of the plurality of software components.

13. The method of claim 12 wherein the plurality of software component comprises a plurality of common application program interfaces (CAPIs) for a plurality of middleware components, respectively, wherein each of the plurality of CAPIs is configured to exchange information with any one of the plurality of application programs executing on a microprocessor unit (MCU), wherein each of the plurality of CAPIs is independent of an implementation of its corresponding middleware component.

14. The method of claim 12 wherein the plurality of software components comprise a first common device driver (CDD), wherein the first CDD is configured to read first configuration information stored in flash memory of the MCU, wherein the first CDD is configured to operate according to the first configuration information.

15. The method of claim 12 wherein the plurality of software components comprise a first common application program interface (CAPI) that provides one or more first services to an application executing on the MCU, wherein the first CAPI is implementation independent.

16. The method of claim 15 wherein the plurality of software components comprise a first software component corresponding to the first CAPI, wherein the first software component comprises a stack off software modules, wherein at least one of the software modules can be replaced in the stack with another software module.

17. The method of claim 12 further comprising a server transmitting the package to the computer system.

18. The method of claim 7 wherein the plurality of software components and the RTOS are tested to insure interoperability with each other.

19. The method of claim 18 wherein the plurality of software components are not tested for interoperability with another operating system.

20. The method of claim 12 wherein the plurality of software components and the RTOS are configured for implementation on any one of a plurality of MCUs having different hardware characteristics, wherein the plurality of software components comprise a plurality of common device drivers, wherein the plurality of software components comprise a plurality of middleware components, wherein the plurality of common device drivers abstracts any one of the plurality of MUCs for the plurality of middleware components.
